(19) United States
(12) Patent Application Publication
(10) Pub. No.: US 2009/0087129 A1
(43) Pub. Date: Apr. 2, 2009

(54) Bearing structure

(75) Inventors: Alex Horng, Kaohsiung City (TW); Ming-Chien Wu, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 11/987,043

(22) Filed: Nov. 27, 2007

(30) Foreign Application Priority Data
Sep. 28, 2007 (TW) 096136148

(51) Int. Cl. F16C 3/00; F16C 17/02

(52) U.S. Cl. 384/322; 184/5.1

(57) ABSTRACT

The present invention relates to a bearing structure having a top end face, a bottom end face, and a bore communicating with the top and bottom end faces, and having at least two oil-guide channel disposed on the inner wall of the bore, extending axially and penetrating one of the same end faces of the bearing. When the present invention is applied to a motor structure, the oil-guide channel is upwardly or downwardly disposed by penetrating the top or bottom end face of the bearing. Hence, when lubricant is churned by the spindle to permeate and diffuse, the oil-guide channel can block and collect the rising lubricant for the bearing to absorb, circulate and reuse again in a timely manner, thereby effectively preventing lubricant from draining and prolonging the operational lifespan of a motor.

### FIELD OF THE INVENTION

The present invention relates to a bearing structure, and more particularly to a practical structure providing functions for blocking, storing and circulating lubricant so as to improve the rotation efficiency of a motor and prolong the operational lifespan of the motor.

### BACKGROUND OF THE INVENTION

A motor can be also termed as the heart of electronic products. The hunger of modern technology chasing for higher rotation speed of motor seems to be endless. However, the improvement of the rotation speed of a motor is usually limited by the lubrication condition of bearing. Consequently, it is the key factor to increase the rotation speed of a motor by searching for a better lubrication technique to effectively prevent lubricant from draining.

As shown in FIG. 1 illustrating an example of a cooling fan motor, the motor mainly includes a rotor 10 and a stator 20, in which a spindle 11 is centrally disposed in the rotor 10, the stator 20 is disposed on the outer periphery of a shaft tube 21, and the shaft tube 21 is fixed on a base 22.

A bearing 30 is sleeved by the shaft tube 21. The bearing 30 is held and limited by a positioning ring 23 and a bottom cap 24. Hence, the spindle 11 of the rotor 10 can penetrate through the bore 30 of the bearing 30 and rotate therein, and is clipped and retained by a snap ring 25 disposed underneath the bearing 30 in advance to prevent the rotor 10 from coming off.

Together with the reference to FIG. 2, a space between an internal portion of the shaft tube 21 and the bottom cap 24 is provided to store lubricant for lubrication between the spindle 11 and the bearing 30 so as to reduce friction and abrasion therebetween.

However, in a conventional motor structure, when the spindle 11 of the rotor 10 is rotating, as a result of the centrifugal force, lubricant stored in the internal space of the shaft tube 21 will permeate and diffuse along the spindle 11, ascend along a gap between the spindle 11 and the shaft tube 31, and drain out directly from the positioning ring 23. As lubricant is the lubrication medium for the spindle 11 to rotate with respect to the bearing 30, the drainage of lubricant will directly impact on the rotation efficiency of the spindle 11 and the abrasion of the bearing 30.

As such, to prevent the abrasion of the bearing, enhance the rotation efficiency of the spindle and prolong the lifespan of the motor, a better lubrication technique featuring multiple functions for blocking, storing and circulating lubricant shall be identified to completely tackle the aforementioned problems.

### SUMMARY OF THE INVENTION

In view of the foregoing concern, the present invention thus provides a bearing structure featuring functions for blocking, storing and circulating lubricant so as to enhance the rotation efficiency of a motor and prolong the operational lifespan of a motor.

The bearing structure includes a bearing having a top end face, a bottom end face and a bore communicating with the top end face and the bottom end face, wherein at least two oil-guide channel are disposed on the inner wall of the bore, and the oil-guide channel is axially extended along the bore and penetrates through one of the same end faces of the bearing.

Moreover, when the present invention is applied to a motor structure, two operation conditions are allowed. One is to upwardly arrange the oil-guide channel toward the end face of the bearing penetrated by the oil-guide channel. The other is to downwardly arrange the oil-guide channel toward the end face of the bearing penetrated by the oil-guide channel.

Hence, when the spindle is rotating, regardless of whether the oil-guide channel penetrates through a corresponding end face to be upwardly or downwardly disposed, the oil-guide channel blocks the capillary effect causing lubricant to ascend on the one hand, and serves as a space for storing and buffering lubricant on the other hand, so as to provide the bearing to absorb, circulate and reuse lubricant again and effectively prevent lubricant from draining.

### BRIEF DESCRIPTION OF THE DRAWINGS

FIG. 1 is a cross-sectional schematic view showing a conventional structure;

FIG. 2 is a partially enlarged schematic view showing the conventional structure;

FIG. 3 is an external schematic view showing the first preferred embodiment of the present invention;

FIG. 4 is an external schematic view showing the second preferred embodiment of the present invention;

FIG. 5 is a partially enlarged schematic view (I) showing the first preferred embodiment of the present invention applied to a motor structure; and

FIG. 6 is a partially enlarged schematic view (II) showing the first preferred embodiment of the present invention applied to a motor structure.

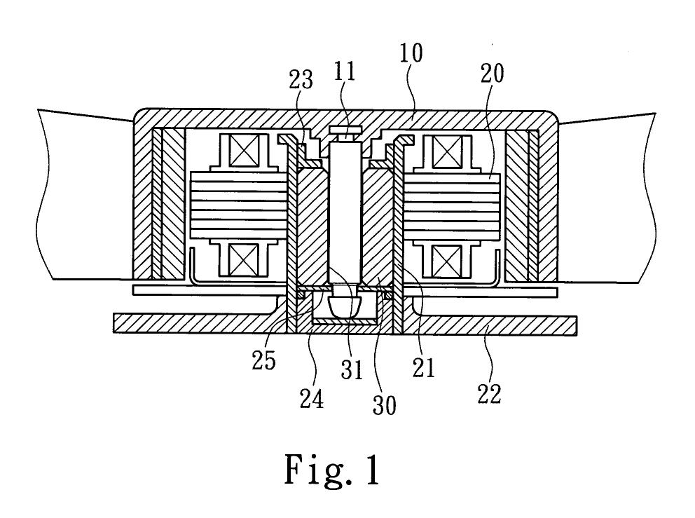

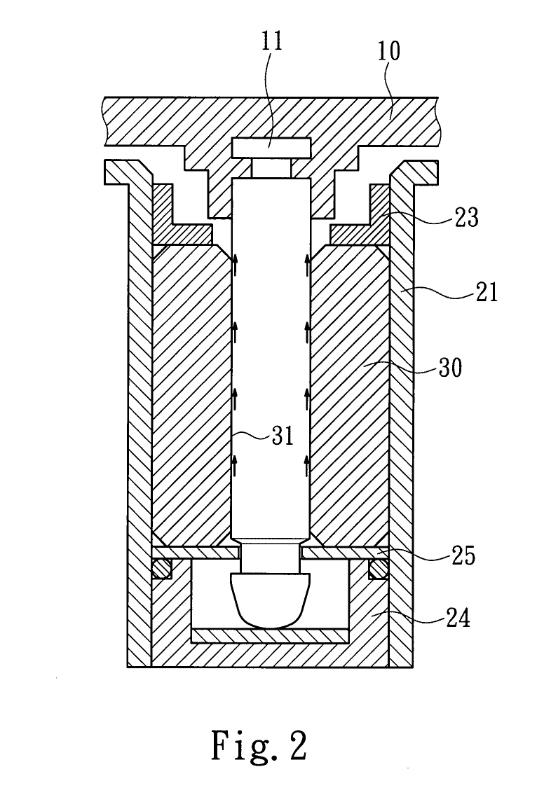

### DETAILED DESCRIPTION OF THE PREFERRED EMBODIMENT

To make the object, features and efficacy of the present invention more comprehensive, two preferred embodiments of the present invention are enumerated along with the detailed illustrative description.

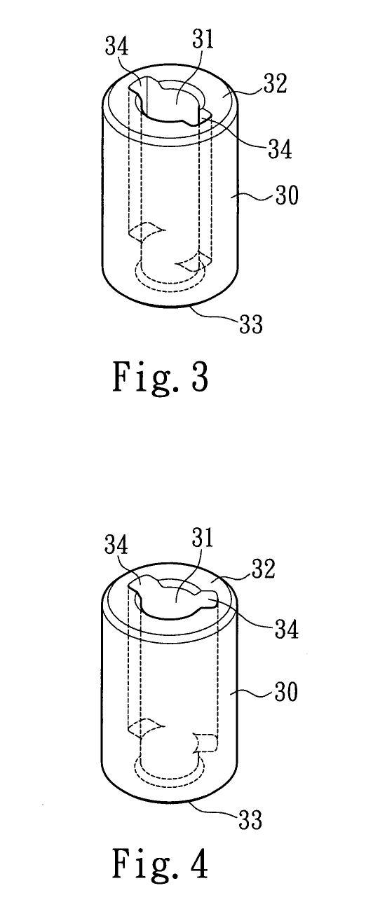

Please refer to FIG. 3, which shows the first preferred embodiment. The bearing structure includes a bearing 30 having a top end face 32, a bottom end face 33 and a bore 31 communicating with the top and bottom end faces 32, 33.

At least two oil-guide channel 34 with a corresponding design are disposed on the inner wall of the bore 31 of the bearing 30, and the oil-guide channel 34 is a straight channel axially stretched along the bore 31 and penetrating through one of the same end faces of the bearing. As shown in FIG. 3, the oil-guide channel 34 penetrates through the top end face 32 of the bearing 30. Besides, after the oil-guide channel 34 penetrates through the top end face 32 of the bearing 30, a radial slot can be disposed on the top end face 32 so as to provide a communicating channel (not shown) between the outer wall of the bearing 30 and the bore 31.

Please further refer to FIG. 4, which shows the second preferred embodiment of the present invention. Similarly, the bearing structure includes a bearing 30 having a top end face 32, a bottom end face 33 and a bore 31 communicating with the top and bottom end faces 32, 33.

At least two oil-guide channels 34 are disposed on the inner wall of the bore 31 of the bearing 30 and the two oil-guide channels 34 with a asymmetrical design are axially extended to penetrate through a same end face.

When the present invention is applied to a motor structure, two operation conditions are allowed:

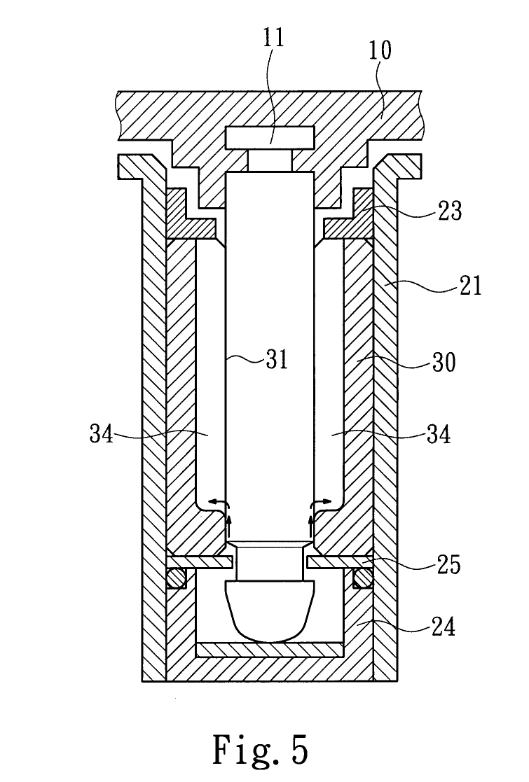

As shown in FIG. 5, which is a partially enlarged schematic view (I) showing the first preferred embodiment applied to a motor structure, the oil-guide channel 34 is upwardly disposed by penetrating through the upper end face so that a section of the bore 31 where the oil-guide channel 34 does not penetrate through the other end face is located at a lower portion.

Thus, when the spindle 11 of the rotor 10 is rotating, lubricant stored in the internal space of the shaft tube 21 is fully kept between the internal space of the shaft tube 21 and the bottom cap 24 mostly because the bore 31 is blocked by the non-communicating section of the oil-guide channel 34, and there is only little amount of oil seepage or oil film permeating and diffusing along the spindle 11 due to the centrifugal force out of the rotation of the spindle 11 and ascending along the gap between the spindle 11 and the bore 31. At the moment, the oil-guide channel 34 can block the rising capillary effect of lubricant in a timely manner and collect lubricant therein to prevent lubricant from spilling. On the one hand, lubricant is avoided to keep permeating upwardly, and on the other hand, the oil-guide channel can also serve as a space for storing and buffering lubricant. Moreover, after lubricant is collected in the oil-guide channel 34, lubricant can be absorbed by the bearing 30 again for circulation and reuse, thereby effectively avoiding the lubricant drainage.

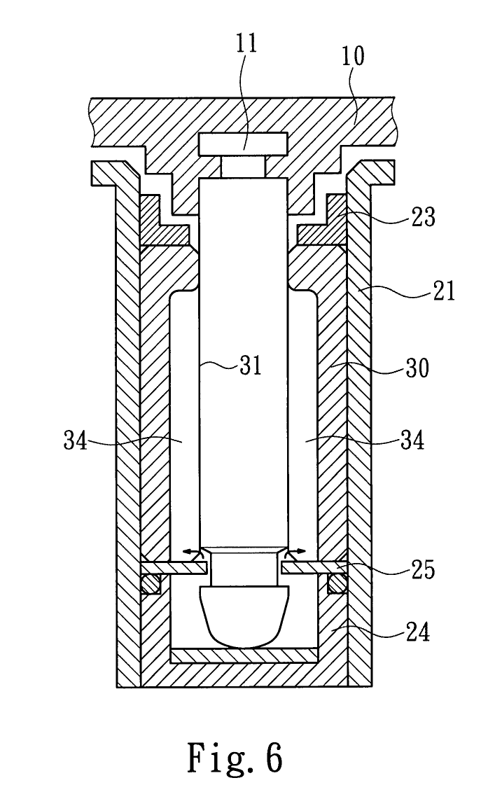

Furthermore, as shown in FIG. 6, which is a partially enlarged schematic view (II) showing the first preferred embodiment applied to a motor structure, the oil-guide channel 34 is downwardly disposed by penetrating the lower end face of the bearing 30 so that a section of the bore 31 where the oil-guide channel 34 does not penetrate through the other end face is located at an upper portion.

Consequently, when the spindle 11 of the rotor 10 is rotating, the oil-guide channel 34 is used to block the rising capillary effect of lubricant and collect lubricant in the oil-guide channel 34 in formation an oil storage space, so as to block lubricant seepage from upwardly permeating and similarly preventing lubricant from draining in an effective manner.

In sum, the present invention not only blocks lubricant from rising up but also provides the flow-guiding, storing and buffering effect of lubricant. Therefore, lubricant can be absorbed by the bearing in a timely manner for circulation and reuse, thereby effectively preventing lubricant from losing, avoiding abrasion of the bearing, increasing the rotation efficiency of the spindle, and prolonging the operational lifespan of the motor. From the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A bearing structure, comprising:
a top end face;
a bottom end face; and
a bore communicating with said top end face and said bottom end face, and having at least two oil-guide channel disposed on an inner wall of said bore, extending axially and penetrating through one of a same said end faces.

2. The bearing structure as set forth in claim 1, wherein said oil-guide channel is a straight channel axially extending along said bore.

3. The bearing structure as set forth in claim 1, wherein said oil-guide channel penetrates through said top end face to be disposed upwardly when said bearing structure is applied to a motor structure.

4. The bearing structure as set forth in claim 1, wherein said oil-guide channel penetrates through said bottom end face to be disposed downwardly when said bearing structure is applied to a motor structure.

5. The bearing structure as set forth in claim 1, wherein said oil-guide channel has a corresponding design when there are at least two oil-guide channels.

6. The bearing structure as set forth in claim 1, wherein said oil-guide channel has a asymmetrical design when there are at least two oil-guide channels.
